(19) United States
(12) Patent Application Publication
(10) Pub. No.: US 2026/0194640 A1
(43) Pub. Date: Jul. 9, 2026

(54) SPECKLE REDUCTION USING REDUNDANT MEASUREMENTS

(71) Applicant: AEVA, INC., Mountain View, CA (US)

(72) Inventors: Behsan Behzadi, Menlo Park, CA (US); Yasin Karimi Chalmiani, Santa Clara, CA (US); Huiyuan Liu, San Jose, CA (US); Mina Rezk, Haymarket, VA (US)

(21) Appl. No.: 19/009,388

(22) Filed: Jan. 3, 2025

(51) Int. Cl. G01S 7/493; G01S 17/931

(52) U.S. Cl. CPC G01S 7/493; G01S 17/931

(57) ABSTRACT

A method of operating a light detection and ranging (LIDAR) system is provided that includes generating a set of optical beams, wherein at least one property is varied across the optical beams, transmitting the optical beams toward a target, and receiving a return signal from each of the optical beams reflected from the target. The method further includes generating detection signals based on each of the return signals, determining, for each of the detection signals, a characteristic of the target to produce a set of data points for the target, and determining an updated characteristic of the target based on the set of data points for the target.

### TECHNICAL FIELD

The present disclosure relates generally to a light detection and ranging (LIDAR) system that utilizes redundant measurements with varying optical beam properties to reduce speckle.

### BACKGROUND

Frequency-Modulated Continuous-Wave (FMCW) LiDAR systems include several possible phase impairments such as laser phase noise, circuitry phase noise, flicker noise that the driving electronics inject on a laser, drift over temperature / weather, and chirp rate offsets. Additionally, target properties and optical beam properties can cause varying phase impairments, such as speckle. For example, in any coherent LiDAR system, the returning signal from a surface exhibiting diffuse scattering is susceptible to the influence of speckle, an interference pattern occurring in the far-field as a result of multiple scattering centers on a diffuse reflector.

### SUMMARY

The present disclosure includes, without limitation, the following example implementations.

Some example implementations provide a method of operating a light detection and ranging (LIDAR) system including generating a plurality of optical beams, wherein a property is varied across the plurality of optical beams, transmitting the plurality of optical beams toward a target, receiving a return signal from each of the plurality of optical beams reflected from the target, generating a plurality of detection signals based on the plurality of return signals, determining, for each of the plurality of detection signals, a characteristic of the target to produce a plurality of data points for the target, and determining an updated characteristic of the target based on the plurality of data points for the target.

In some embodiments, determining the updated characteristic of the target comprises calculating one of an average or a weighted average of the plurality of data points for the target. In some embodiments, determining the updated characteristic includes determining whether each of the plurality of data points of the target are valid based on one or more of a threshold velocity, a threshold range, or a threshold intensity and removing invalid data points from the determination of the updated characteristic.

In some embodiments, the at least one property that is varied across the plurality of optical beams comprises a spatial adjustment between the plurality of optical beams. In some embodiments, the spatial adjustment comprises selecting between a plurality of output optical paths. In some embodiments, the at least one property that is varied across the plurality of optical beams comprises a varied wavelength of the plurality of optical beams. In some embodiments, varying the wavelength of the plurality of optical beams comprises selecting an output beam from one of a plurality of optical sources. In some embodiments, the at least one property that is varied across the plurality of optical beams comprises a varied polarization state of an output optical beam. In some embodiments, varying the polarization state comprises randomly varying the polarization state via a polarization randomizer. In some embodiments, varying the polarization state comprises selecting, via a switch in an output path, a polarization of an output optical beam. In some embodiments, the at least one property that is varied across the plurality of optical beams comprises a varied polarization of a local oscillator.

Another example implementation provides a light detection and ranging (LIDAR) system including one or more optical sources to generate a plurality of optical beams, wherein a property is varied across the plurality of optical beams, integrated photonics and scanning optics to transmit the plurality of optical beams toward a target and receive a return signal from each of the plurality of optical beams reflected from the target, a plurality of optical detectors to generate a plurality of detection signals based on the plurality of return signals, and a processing device, operatively coupled to the plurality of optical detectors, to determine, for each of the plurality of detection signals, a characteristic of the target to produce a plurality of data points for the target and determine an updated characteristic of the target based on the plurality of data points for the target.

These and other features, aspects, and advantages of the present disclosure will be apparent from a reading of the following detailed description together with the accompanying FIG.s, which are briefly described below. The present disclosure includes any combination of two, three, four or more features or elements set forth in this disclosure, regardless of whether such features or elements are expressly combined or otherwise recited in a specific example implementation described herein. This disclosure is intended to be read holistically such that any separable features or elements of the disclosure, in any of its aspects and example implementations, should be viewed as combinable unless the context of the disclosure clearly dictates otherwise.

It will therefore be appreciated that this Brief Summary is provided merely for purposes of summarizing some example implementations so as to provide a basic understanding of some aspects of the disclosure. Accordingly, it will be appreciated that the above described example implementations are merely examples and should not be construed to narrow the scope or spirit of the disclosure in any way. Other example implementations, aspects, and advantages will become apparent from the following detailed description taken in conjunction with the accompanying FIG.s which illustrate, by way of example, the principles of some described example implementations.

### BRIEF DESCRIPTION OF THE FIGURES

Embodiments and implementations of the present disclosure will be understood more fully from the detailed description given below and from the accompanying drawings of various aspects and implementations of the disclosure, which, however, should not be taken to limit the disclosure to the specific embodiments or implementations, but are for explanation and understanding only.

FIG. 1 is a block diagram illustrating an example LIDAR system according to embodiments of the present disclosure.

FIG. 2 is a time-frequency diagram illustrating an example of FMCW LIDAR waveforms according to embodiments of the present disclosure.

FIG. 3 illustrates an example LiDAR system with redundant spatially varying output beams, according to embodiments of the present disclosure.

FIG. 4 illustrates an example LiDAR system including an optical switch for varying a selected output beam or beams for redundant and spatially varying target measurements, according to embodiments of the present disclosure.

FIG. 5 illustrates an example LiDAR system including an optical switch for varying a selected detection cell or detection cells for redundant and spatially varying target measurements, according to embodiments of the present disclosure.

FIG. 6 illustrates an example LiDAR system including multiple optical sources for selection of varying frequency ranges of an output optical beam to generate redundant and frequency varied target measurements.

FIG. 7 illustrates an example LiDAR system including multiple optical beams to generate redundant and frequency varied target measurements, according to embodiment of the present disclosure.

FIG. 8 illustrates an example LiDAR system including multiple optical beams in combination with multiple sensing cells for spatially varying and frequency varying output optical beams for redundant target measurements, according to embodiments of the present disclosure.

FIG. 9 illustrates an example LiDAR system including optical circuity to perform target measurements using both TE and TM polarizations via separate optical beams, according to embodiments of the present disclosure.

FIG. 10 illustrates another example LiDAR system including optical circuity to perform target measurements using both TE and TM polarizations via separate optical beams, according to embodiments of the present disclosure.

FIG. 11 illustrates an example LiDAR system including integrated photonics circuitry to generate varying and randomized polarizations for multiple output optical beams to generate redundant target measurements, according to some embodiments.

FIG. 12 illustrates an example LiDAR system including integrated photonics circuity to vary and randomize local oscillator polarizations for combination with multiple optical beams to generate redundant target measurements, according to embodiments of the present disclosure.

FIG. 13 illustrates an example LiDAR system including multiple counter-chirped optical beams and integrated photonics circuitry to randomly vary a polarization of the optical beams to produce redundant target measurements, according to embodiments of the disclosure.

FIG. 14 is a flow diagram illustrating a method of speckle reduction using multiple redundant target measurements, according to embodiments of the disclosure.

FIG. 15 is a flow diagram illustrating another method of speckle reduction using multiple redundant target measurements, according to embodiments of the disclosure.

FIG. 16 is a flow diagram illustrating a method of speckle reduction using two redundant target measurements, according to embodiments of the present disclosure.

FIG. 17 is a flow diagram illustrating an example method of speckle reduction in a LiDAR system using any arbitrary number of redundant target measurements, according to embodiments of the present disclosure.

### DETAILED DESCRIPTION

Various embodiments and aspects of the disclosures will be described with reference to details discussed below, and the accompanying drawings will illustrate the various embodiments. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosures.

The described LIDAR systems herein may be implemented in any sensing market, such as, but not limited to, transportation, manufacturing, metrology, medical, virtual reality, augmented reality, and security systems. According to some embodiments, the described LIDAR system may be implemented as part of a front-end of frequency modulated continuous-wave (FMCW) device that assists with spatial awareness for automated driver assist systems, or self-driving vehicles.

In FMCW LiDAR, the range determination fundamentally hinges on the frequency-dependent optical phase of the returning signal. In an ideal scenario, this value would exclusively rely on the actual range as the laser spot traverses a rugged surface, permitting the system to map the inherent surface roughness. The presence of speckle, however, introduces additional perturbations to the optical phase. Initially, pronounced speckle-induced phase fluctuations may manifest as the source optical frequency traverses the optical bandwidth of the optical source, decreasing the signal intensity to noise level and leading to supplementary range fluctuations, including potentially significant range outliers as well as false alarm detection. These supplementary range fluctuations can readily overshadow the inherent variations in surface range, particularly in systems characterized by a limited optical bandwidth. Secondly, when the laser beam undergoes lateral scanning across the surface during data acquisition, as is the case in surface mapping applications, time-dependent speckle spatial phase is introduced, giving rise to optical frequency fluctuations. These fluctuations translate into additional uncertainties in range measurements.

Embodiments of the present disclosure address the problems introduced by speckle in return signals in an FMCW LiDAR system by providing independent and redundant measurement within an integration period by varying one or more properties of the optical beam output by the LiDAR system. As discussed in more detail below, the varied properties may include spatial variation, polarization variation, frequency/wavelength variation, any other beam property variations, or a combination of variations. Accordingly, the redundant measurements can be used to perform additional filtering and calculations to account for and reduce the effects of speckle at each collected data point in scanned scene.

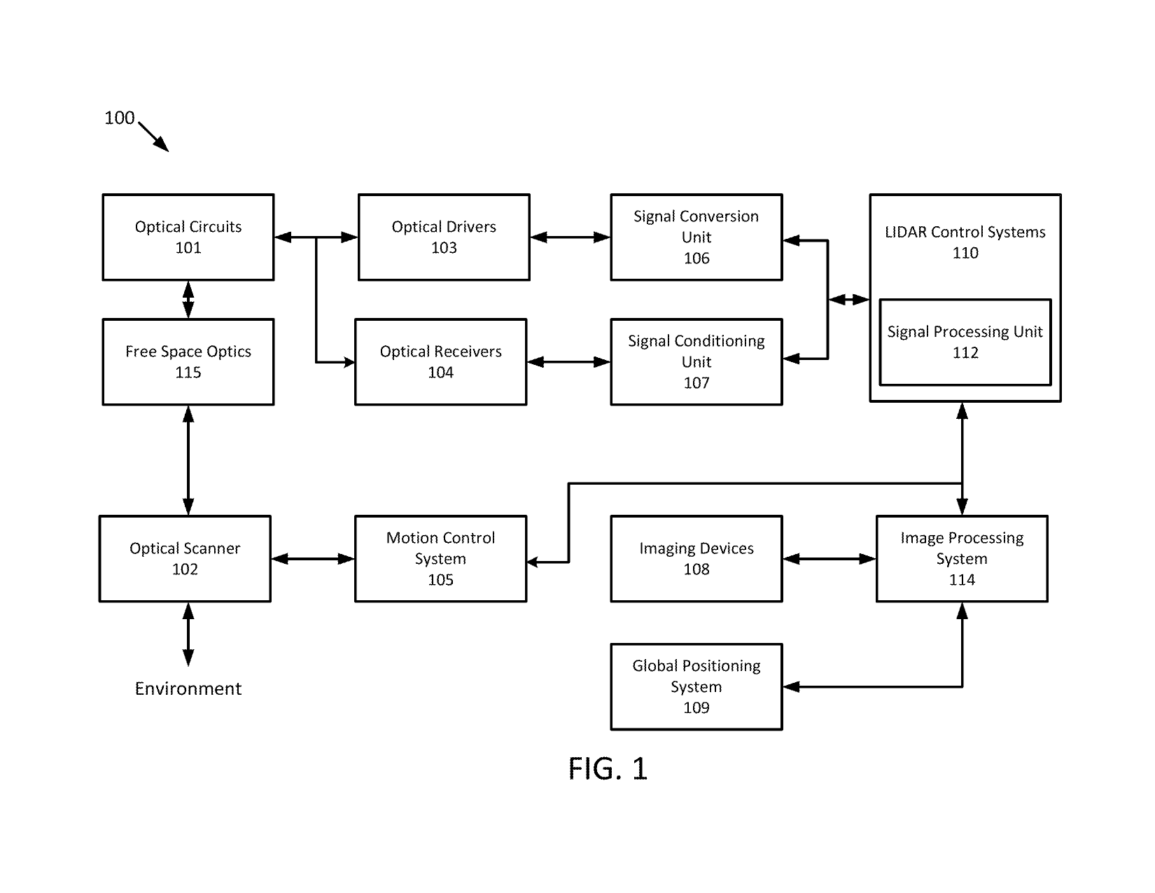

FIG. 1 illustrates a LIDAR system 100 according to example implementations of the present disclosure. The LIDAR system 100 includes one or more of each of a number of components, but may include fewer or additional components than shown in FIG. 1. According to some embodiments, one or more of the components described herein with respect to LIDAR system 100 can be implemented on a photonics chip. The optical circuits 101 may include a combination of active optical components and passive optical components. Active optical components may generate, amplify, and/or detect optical signals and the like. In some examples, the active optical component includes optical beams at different wavelengths, and includes one or more optical amplifiers, one or more optical detectors, or the like.

Free space optics 115 may include one or more optical waveguides to carry optical signals, and route and manipulate optical signals to appropriate input / output ports of the active optical circuit. The free space optics 115 may also include one or more optical components such as taps, wavelength division multiplexers (WDM), splitters / combiners, polarization beam splitters (PBS), collimators, couplers or the like. In some examples, the free space optics 115 may include components to transform the polarization state and direct received polarized light to optical detectors using a PBS, for example. The free space optics 115 may further include a diffractive element to deflect optical beams having different frequencies at different angles.

In some examples, the LIDAR system 100 includes an optical scanner 102 that includes one or more scanning mirrors that are rotatable along an axis (e.g., a slow-moving-axis) that is orthogonal or substantially orthogonal to the fast-moving-axis of the diffractive element to steer optical signals to scan a target environment according to a scanning pattern. For instance, the scanning mirrors may be rotatable by one or more galvanometers. Objects in the target environment may scatter an incident light into a return optical beam or a target return signal. The optical scanner 102 also collects the return optical beam or the target return signal, which may be returned to the passive optical circuit component of the optical circuits 101. For example, the return optical beam may be directed to an optical detector by a polarization beam splitter. In addition to the mirrors and galvanometers, the optical scanner 102 may include components such as a quarter-wave plate, lens, anti-reflective coating window or the like.

To control and support the optical circuits 101 and optical scanner 102, the LIDAR system 100 includes LIDAR control systems 110. The LIDAR control systems 110 may include a processing device for the LIDAR system 100. In some examples, the processing device may be one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. The processing device may also be one or more special-purpose processing devices such as an application specific integrated circuit (ASIC), a field programmable gate array (FPGA), a digital signal processor (DSP), network processor, or the like.

In some examples, the LIDAR control systems 110 may include a signal processing unit 112 such as a digital signal processor (DSP). The LIDAR control systems 110 are configured to output digital control signals to control optical drivers 103. In some examples, the digital control signals may be converted to analog signals through signal conversion unit 106. For example, the signal conversion unit 106 may include a digital-to-analog converter. The optical drivers 103 may then provide drive signals to active optical components of optical circuits 101 to drive optical sources such as lasers and amplifiers. In some examples, several optical drivers 103 and signal conversion units 106 may be provided to drive multiple optical sources.

The LIDAR control systems 110 are also configured to output digital control signals for the optical scanner 102. A motion control system 105 may control the galvanometers of the optical scanner 102 based on control signals received from the LIDAR control systems 110. For example, a digital-to-analog converter may convert coordinate routing information from the LIDAR control systems 110 to signals interpretable by the galvanometers in the optical scanner 102. In some examples, a motion control system 105 may also return information to the LIDAR control systems 110 about the position or operation of components of the optical scanner 102. For example, an analog-to-digital converter may in turn convert information about the galvanometers’ position to a signal interpretable by the LIDAR control systems 110.

The LIDAR control systems 110 are further configured to analyze incoming digital signals. In this regard, the LIDAR system 100 includes optical receivers 104 to measure one or more beams received by optical circuits 101. For example, a reference beam receiver may measure the amplitude of a reference beam from the active optical component, and an analog-to-digital converter converts signals from the reference receiver to signals interpretable by the LIDAR control systems 110. Target receivers measure the optical signal that carries information about the range and velocity of a target in the form of a beat frequency, modulated optical signal. The reflected beam may be mixed with a second signal from a local oscillator. The optical receivers 104 may include a high-speed analog-to-digital converter to convert signals from the target receiver to signals interpretable by the LIDAR control systems 110. In some examples, the signals from the optical receivers 104 may be subject to signal conditioning by signal conditioning unit 107 prior to receipt by the LIDAR control systems 110. For example, the signals from the optical receivers 104 may be provided to an operational amplifier for amplification of the received signals and the amplified signals may be provided to the LIDAR control systems 110.

In some applications, the LIDAR system 100 may additionally include one or more imaging devices 108 configured to capture images of the environment, a global positioning system 109 configured to provide a geographic location of the system, or other sensor inputs. The LIDAR system 100 may also include an image processing system 114. The image processing system 114 can be configured to receive the images and geographic location, and send the images and location or information related thereto to the LIDAR control systems 110 or other systems connected to the LIDAR system 100.

In operation according to some examples, the LIDAR system 100 is configured to use nondegenerate optical sources to simultaneously measure range and velocity across two dimensions. This capability allows for real-time, long range measurements of range, velocity, azimuth, and elevation of the surrounding environment.

In some examples, the scanning process begins with the optical drivers 103 and LIDAR control systems 110. The LIDAR control systems 110 instruct the optical drivers 103 to independently modulate one or more optical beams, and these modulated signals propagate through the passive optical circuit to the collimator. The collimator directs the light at the optical scanning system that scans the environment over a preprogrammed pattern defined by the motion control system 105. The optical circuits 101 may also include a polarization wave plate (PWP) to transform the polarization of the light as it leaves the optical circuits 101. In some examples, the polarization wave plate may be a quarter-wave plate or a half-wave plate. A portion of the polarized light may also be reflected back to the optical circuits 101. For example, lensing or collimating systems used in LIDAR system 100 may have natural reflective properties or a reflective coating to reflect a portion of the light back to the optical circuits 101.

Optical signals reflected back from the environment pass through the optical circuits 101 to the receivers. Because the polarization of the light has been transformed, it may be reflected by a polarization beam splitter along with the portion of polarized light that was reflected back to the optical circuits 101. Accordingly, rather than returning to the same fiber or waveguide as an optical source, the reflected light is reflected to separate optical receivers. These signals interfere with one another and generate a combined signal. Each beam signal that returns from the target produces a time-shifted waveform. The temporal phase difference between the two waveforms generates a beat frequency measured on the optical receivers (photodetectors). The combined signal can then be reflected to the optical receivers 104.

The analog signals from the optical receivers 104 are converted to digital signals using analog to digital converters (ADCs). The digital signals are then sent to the LIDAR control systems 110. A signal processing unit 112 may then receive the digital signals and interpret them. In some embodiments, the signal processing unit 112 also receives position data from the motion control system 105 and galvanometers (not shown) as well as image data from the image processing system 114. The signal processing unit 112 can then generate a 3D point cloud with information about range and velocity of points in the environment as the optical scanner 102 scans additional points. The signal processing unit 112 can also overlay a 3D point cloud data with the image data to determine velocity and distance of objects in the surrounding area. The system also processes the satellite-based navigation location data to provide a precise global location.

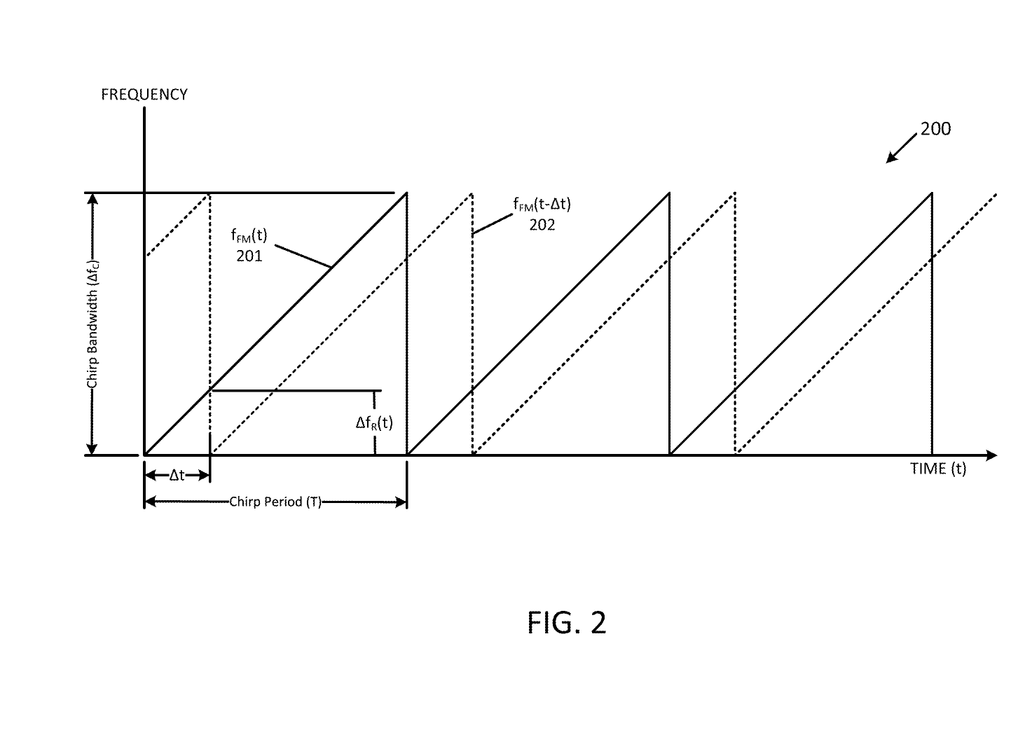

FIG. 2 is a time-frequency diagram 200 of an FMCW scanning signal 101b that can be used by a LIDAR system, such as system 100, to scan a target environment according to some embodiments. In one example, the scanning waveform 201, labeled as f_{FM}(t), is a sawtooth waveform (sawtooth “chirp”) with a chirp bandwidth Δf_{C} and a chirp period T_{C}. The slope of the sawtooth is given as k = (Δf_{C}/T_{C}). FIG. 2 also depicts target return signal 202 according to some embodiments. Target return signal 202, labeled as f_{FM}(t-Δt), is a time-delayed version of the scanning signal 201, where Δt is the round trip time to and from a target illuminated by scanning signal 201. The round trip time is given as Δt = 2R/v, where R is the target range and v is the velocity of the optical beam, which is the speed of light c. The target range, R, can therefore be calculated as R = c(Δt/2). When the return signal 202 is optically mixed with the scanning signal, a range-dependent difference frequency (“beat frequency”) Δf_{R}(t) is generated. The beat frequency Δf_{R}(t)is linearly related to the time delay Δt by the slope of the sawtooth k. That is, Δf_{R}(t)= kΔt. Since the target range R is proportional to Δt, the target range R can be calculated as R = (c/2)(Δf_{R}(t)/k). That is, the range R is linearly related to the beat frequency Δf_{R}(t). The beat frequency Δf_{R}(t)can be generated, for example, as an analog signal in optical receivers 104 of system 100. The beat frequency can then be digitized by an analog-to-digital converter (ADC), for example, in a signal conditioning unit such as signal conditioning unit 107 in LIDAR system 100. The digitized beat frequency signal can then be digitally processed, for example, in a signal processing unit, such as signal processing unit 112 in system 100. It should be noted that the target return signal 202 will, in general, also includes a frequency offset (Doppler shift) if the target has a velocity relative to the LIDAR system 100. The Doppler shift can be determined separately, and used to correct the frequency of the return signal, so the Doppler shift is not shown in FIG. 2 for simplicity and ease of explanation. It should also be noted that the sampling frequency of the ADC will determine the highest beat frequency that can be processed by the system without aliasing. In general, the highest frequency that can be processed is one-half of the sampling frequency (i.e., the “Nyquist limit”). In one example, and without limitation, if the sampling frequency of the ADC is 1 gigahertz, then the highest beat frequency that can be processed without aliasing (Δf_{Rmax}) is 500 megahertz. This limit in turn determines the maximum range of the system as Rₘₐₓ = (c/2)(Δf_{Rmax}/k) which can be adjusted by changing the chirp slope k. In one example, while the data samples from the ADC may be continuous, the subsequent digital processing described below may be partitioned into “time segments” that can be associated with some periodicity in the LIDAR system 100. In one example, and without limitation, a time segment might correspond to a predetermined number of chirp periods T, or a number of full rotations in azimuth by the optical scanner.

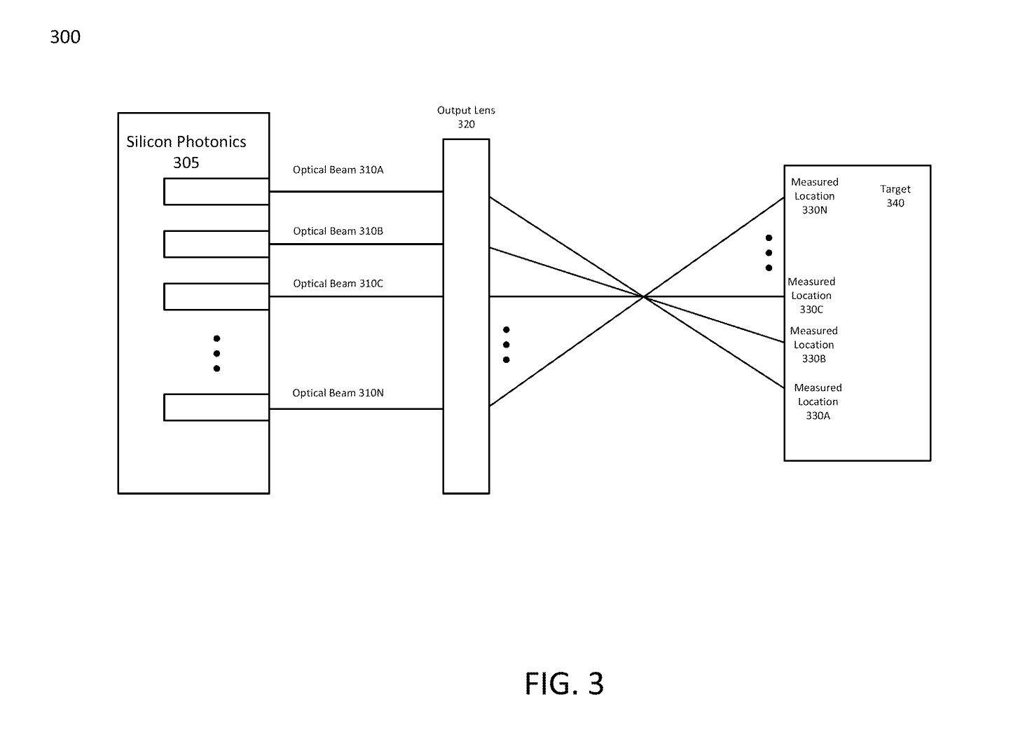

FIG. 3 illustrates an example LiDAR system 300 with redundant spatially varying output beams, according to embodiments of the present disclosure. In some embodiments, one method of producing independent and redundant target measurements includes spatially jittering the output optical beam or placing multiple output beams at different spatial like locations (e.g., output locations). As discussed above, speckle of a return signal is target dependent (e.g., rougher targets have higher speckle) and location dependent (e.g., where on the target the beam is reflected). Thus, providing multiple beams at different locations on the same target provides for varying speckle. Accordingly, embodiments may provide for moving the output beam slightly up and down, left and right, or various directions, to produce multiple measurements that have differing speckle effects.

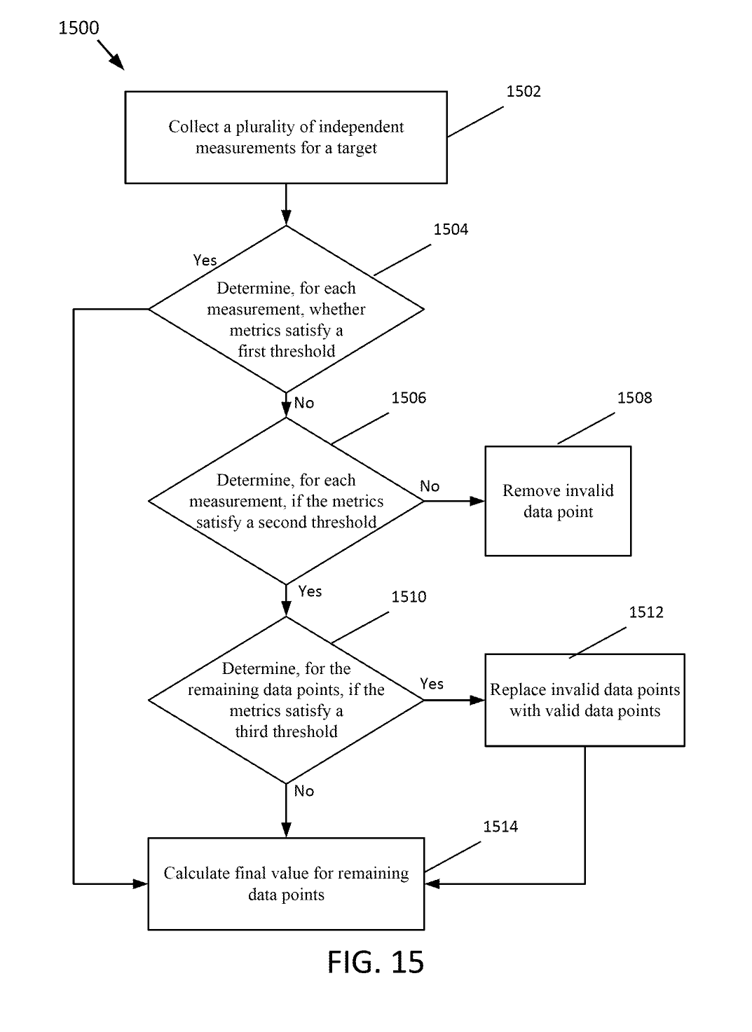

As depicted, a silicon photonics die of the LiDAR system may include multiple optical beam output paths to output an arbitrary number of spatially varying optical beams (e.g., optical beams 310A-N). As can be seen, the offset (e.g., the spatial variation) of each of the optical beams 310A-N may result in a slightly different point of illumination at a target 340. In particular, optics such as an output lens 320 may direct the output beams 310A-N toward the target 340 at varying angles depending on the spatial offset of the optical beam. Thus, each beam may illuminate the different measured locations 330A-N of the target 340, each location producing a different speckle effect in the reflected return beam. Thus, the spatial variation of the output beams 310A-N may produce multiple independent and redundant measurements of the target 340, each with differing speckle effects. As described in more detail below with respect to FIGS. 15-18, the redundant measurements can be used to calculate a more accurate and consistent measurement with reduced effects of speckle.

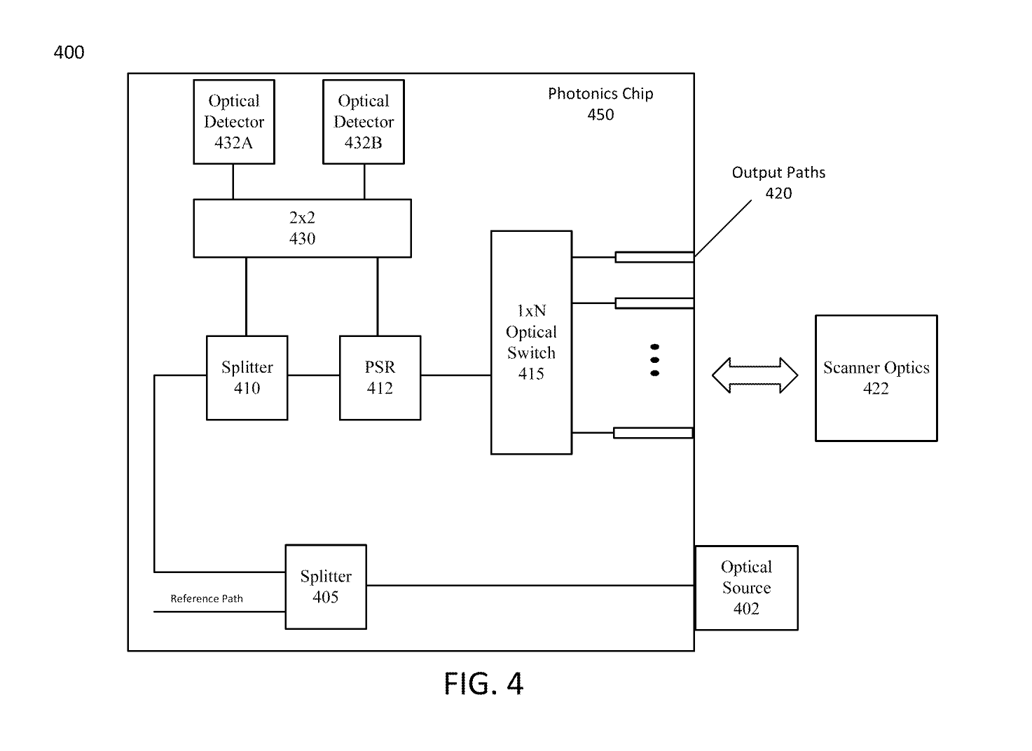

FIG. 4 illustrates an example LiDAR system 400 including an optical switch for varying a selected output beam or beams for redundant and spatially varying target measurements, according to embodiments of the present disclosure. To provide spatially varying output beams, the LiDAR system 400 of FIG. 4 includes several output beam paths that are spatially offset and which are selectable via a switch. For example, a single optical source may be provided to a 1xN optical switch that selects an output path and varies the selected output path to transmit the optical beam from different positions and thus obtain return signals including varying speckle effects. In other words, the beam transmitted from the optical source is directed to differing output paths of the 1xN optical switch over a short period of time to illuminate the same target at different points or locations on the target, thus providing differing levels of speckle in the return signal.

As depicted, an optical source 402 of the LiDAR system may produce an optical beam that is transmitted into a photonics chip 450. The optical beam may then be split into two paths, a reference path and a transmission path. The optical beam in the transmission path may then be directed (e.g., via a waveguide) to another beam splitter 410 to generate a local oscillator beam and a transmission beam. The transmission beam may then be provided to a polarizing beam splitter/rotation (PSR) 412 which rotates a polarization of the transmission beam and directs the transmission beam to a 1xN optical switch 415. The 1xN optical switch 415 may receive a single optical beam and then direct the optical beam to a selected optical output path. For example, the optical switch 415 may be controlled by an electrical signal (e.g., received from a controller) to switch between the various output paths 420. The pattern of output path selection may vary and may include any sequential selection of the differing output paths 420 to produce independent target measurements. The transmission beam may then be transmitted along the selected output path to scanner optics 422 which may include one or more mirrors, lenses, and other optical components to scan a field of view of the LiDAR system 400. The scanner optics 422 may direct the transmission beam toward a target in the FOV, which may reflect at least a portion of the optical beam back to the scanner optics 422, and to the selected path. The return beam may then be directed through the optical switch 415 back to the PSR 412 which directs the return beam, based on its changed polarization after reflection, to one or more optical detections. In particular, the return beam may be directed to a 2x2 selector or switch that combines the local oscillator signal generated from splitter 410 with the return signal and provides the combined signal to two optical detectors 432A-B.

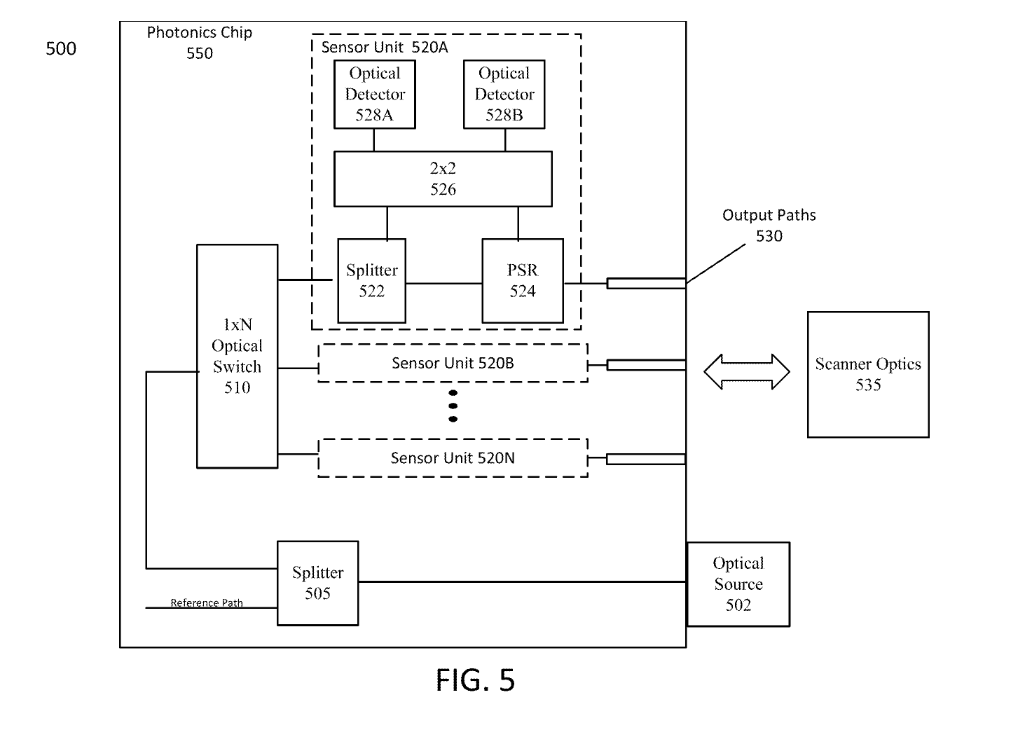

FIG. 5 illustrates an example LiDAR system 500 including an optical switch for varying a selected detection cell or detection cells for redundant and spatially varying target measurements, according to embodiments of the present disclosure. System 500 of FIG. 5 may include multiple output paths, similar to system 400 of FIG. 4. System 500, however, may include a 1xN optical switch 510 prior to multiple sensor units 520A-N in the each of the output paths 530. While the sensing unit in FIG. 4 is placed prior to the optical switch 415, and is thus a common sensing unit for each of the output paths 420, the sensor units 520A-N of FIG. 5 are duplicated within each of the selectable output paths 530. Accordingly, each of the output paths 530 may operate as independent sensors and thus more than one or even all of the sensor units 520A-N and output paths 530 may operate simultaneously. Accordingly, more measurements may be made in a shorter period of time, providing for higher resolution and additional redundant measurements for better speckle reduction in target measurements.

As depicted, LiDAR system 500 includes an optical source 502 to generate a frequency modulated optical beam. The optical source 502 may be coupled to a photonics chip 550 and transmit the optical beam into the photonics chip 550 via an optical waveguide. A splitter 505 may then be split into a reference path and a transmission path by a splitter 505. The transmission path may include an optical switch 510 to select between multiple sensor units 520A-N and output paths 530. Each output path may 530 may be spatially offset from each other to provide spatial variation between output beams. In each output path 530, each sensor unit 520A-N may provide a splitter 522 to generate a local oscillator that is directed to optical detectors and a transmission beam that is directed to a PSR 524. The PSR 524 may direct the transmission beam to a corresponding output path for transmission to toward scanner optics 535. Additionally, the PSR 524 may rotate or select a polarization of the transmission beam. The scanner optics 535 may direct the transmission beam toward a target and direct a return beam to back to the selected output path. The return beam, which has an opposite polarization as the transmitted beam may then be directed by the PSR 524 to a set of optical detectors 528A-B. For example, a 2x2 combiner 526 may combine the local oscillator with the return beam and provide the combined signal to optical detectors 528A-B. The optical detectors 528A-B may each generate an electrical signal based on the combined signal. The electrical signal may include a beat frequency generated by the offset of the phases of the local oscillator and the return beam. Thus, each sensor unit 520A-N may each produce independent and redundant measurements of a target which may then be used to calculate a target measurement with reduced speckle effects, as described with respect to FIGS. 15-18.

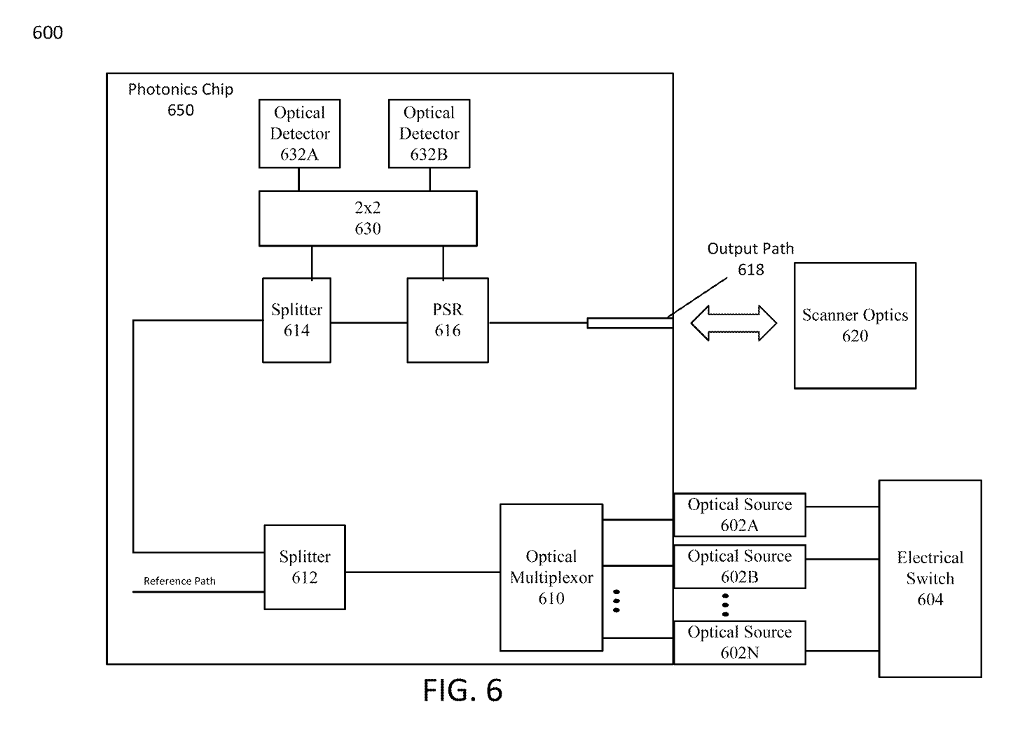

FIG. 6 illustrates an example LiDAR system 600 including multiple optical sources for selection of varying frequency ranges of an output optical beam to generate redundant and frequency varied target measurements. As depicted, FIG. 6 illustrates the use of multiple optical beams to produce differing wavelengths of the output beams. Because speckle is dependent on the characteristic of the illuminating beam, changes in frequency of an optical beam that illuminates the same location on a target may provide differing patterns of speckle. Accordingly, system 600 may include any number of optical beams, each tuned around a differing frequency or wavelength to provide a corresponding number of redundant and independent measurements of a target.

As depicted, LiDAR system 600 includes multiple optical sources 602A-N coupled with a photonics chip 650. The optical sources 602A-N may be controlled and selected by an electrical switch 604. For example, the electrical switch 604 may select, at any given time, which of the optical sources 602A-N is active and transmitting an optical beam into the photonics chip 650. Each optical source 602A-N may be tuned to transmit a particular range of frequencies or wavelengths. Accordingly, the electrical switch 604 may select between various frequency optical beams to transmit through the LiDAR system 600. An optical multiplexor 610 may direct each of the different frequency optical beams from the optical sources 602A-N into a common path when selected. The selected optical beam may then be split into a reference path and a transmission path. The transmission path may include a beam splitter 614 to generate a local oscillator and a transmission beam. The splitter 614 may direct the local oscillator to a 2x2 combiner 630 for combination with a return signal. The transmission beam may then be directed to PSR 616 for polarization and directing of the transmission beam via an output path 618 to scanner optics 620. The scanner optics 620 may direct the transmission beam toward a target and direct a reflected return beam from the target into the output path 618. The PSR 616 may then direct the return beam, based on the polarization of the return beam, to the 2x2 combiner and to optical detectors 632A and 632B.

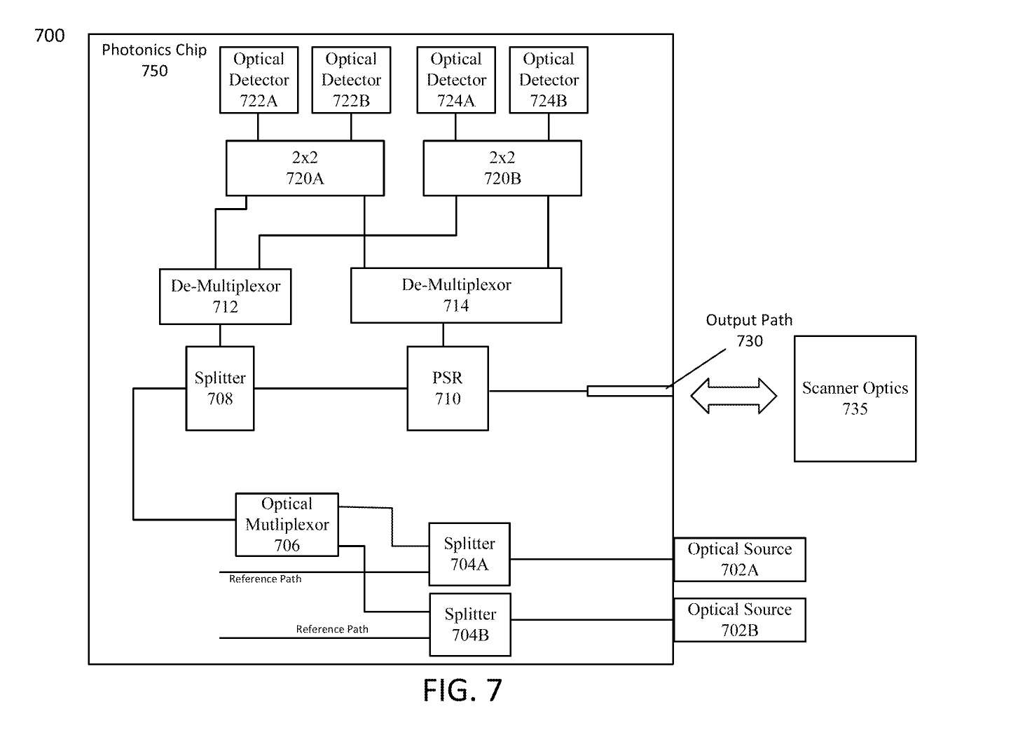

FIG. 7 illustrates an example LiDAR system 700 including multiple optical beams to generate redundant and frequency varied target measurements, according to embodiment of the present disclosure. In some embodiments, LiDAR system 700 includes two optical sources 702A-B, each with a different frequency or frequency modulation. For example, the optical sources 702A-B may be counter-chirped where each beam is modulated about a common or similar frequency but the up chirp of one optical source corresponds to the down chirp of the other source. Thus, each are operating with a differing modulation to produce two differing signals to measure the same target. The optical beam of optical source 702A may be split by splitter 704A into a reference path and a transmission path and the optical beam of optical source 702B may be split by splitter 704B into a reference path and transmission path. The two optical beams may then be combined into a single path via optical multiplexor 706, resulting in a combined beam. A beam splitter 708 may split the combined beam into a local oscillator and a combined transmission beam. The splitter 708 may direct the local oscillator to a wavelength demultiplexor that separates the two beams included in the local oscillator based on the wavelengths of the beams and provides each beam to separate sets of optical detectors. PSR 710 may polarize the combined transmission beam. The transmission beam may be polarized by PSR 710 and transmitted via output path 730 to scanner optics 735. Scanner optics 735 may transmit the combined transmission beam to a target and receive a reflected return signal from the target. The scanner optics 735 may direct the return signal into the output path 730 and to the PSR 710 which directs the polarized return beam to demultiplexor 714. The wavelength demultiplexor 714 may separate the two beams included in the return beam based on the wavelengths of the beams and provides each return beam to separate sets of optical detectors. For example, the local oscillator beam and the transmitted beam from optical source 702A may be directed to a 2x2 combiner 720A and corresponding optical detectors 722A-B while the beams from optical source 702B may be directed to 2x2 combiner 720B and corresponding optical detectors 724A-B. Accordingly, two independent and redundant measurements of a target can be generated via the two different optical beams with differing modulation. The redundant measurements can then be used to compute a final target measurement to reduce effects of noise due to speckle in return signals (e.g., by averaging or other computational methods).

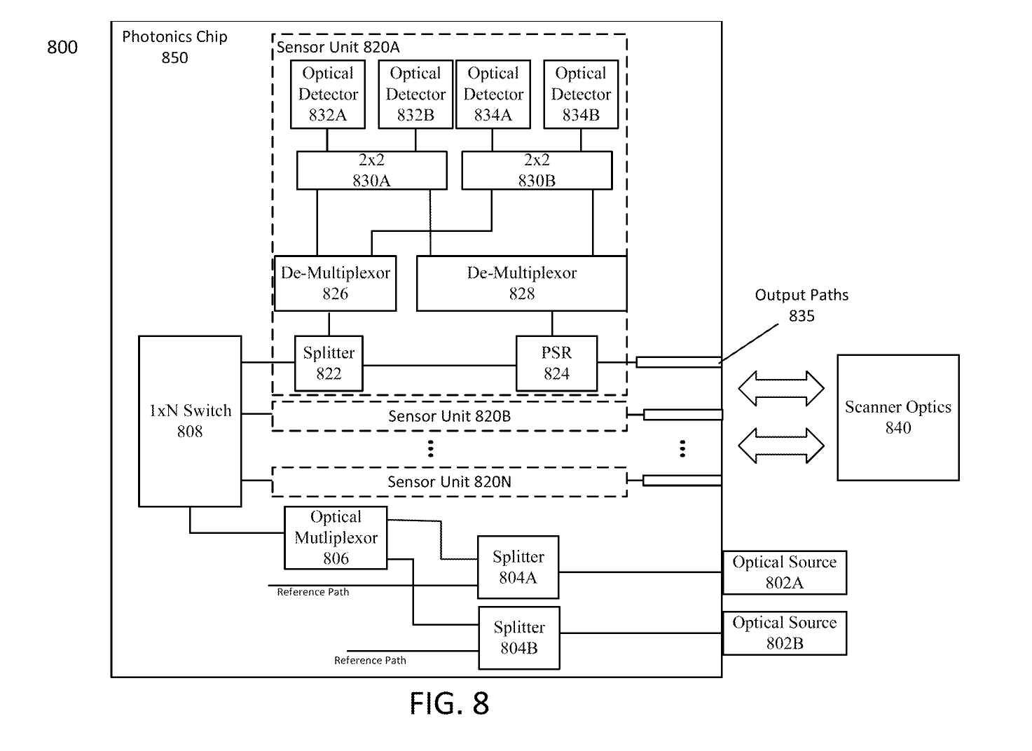

FIG. 8 illustrates an example LiDAR system 800 including multiple optical beams in combination with multiple sensing cells for spatially varying and frequency varying output optical beams for redundant target measurements, according to embodiments of the present disclosure. As discussed above, spatial variation and frequency variation of an output beam can produce differing speckle effects from a target. Accordingly, FIG. 8 provides for multiple output beams with differing frequencies (e.g., counter-chirped, or tuned around differing frequencies), as well as multiple output paths to produce two levels of variation and speckle effects.

Similar to FIG. 7, discussed above, system 800 includes two optical sources 802A-B, each with a different frequency or frequency modulation. For example, the optical sources 802A-B may be counter-chirped where each are modulated about a common or similar frequency but the up chirp of one optical source corresponds to the down chirp of the other source. Thus, each are operating with a differing modulation to produce two differing signals to measure the same target. The optical beam of optical source 802A may be split by splitter 804A into a reference path and a transmission path and the optical beam of optical source 802B may be split by splitter 804B into a reference path and transmission path. The two optical beams may then be combined into a single path via optical multiplexor 806, resulting in a combined beam. A switch 808 may select between multiple output paths 835, each including a separate sensor unit 820A-N. As discussed with respect to FIG. 7, each sensor unit 820A-B may include

With each sensor unit 820A-N, a beam splitter 822 may split the combined beam into a local oscillator and a combined transmission beam. The splitter 822 may direct the local oscillator to a wavelength demultiplexor 826 that separates the two beams included in the local oscillator based on the wavelengths of the beams and provides each beam to separate sets of optical detectors. PSR 824 may polarize the combined transmission beam. The transmission beam may be polarized by PSR 824 and transmitted via the corresponding output path 835 to scanner optics 840. Scanner optics 840 may transmit the combined transmission beam to a target and receive a reflected return signal from the target. The scanner optics 840 may direct the return signal into the corresponding output path 835 and to the PSR 824 which directs the polarized return beam to demultiplexor 828. The wavelength demultiplexor 828 may separate the two beams included in the return beam based on the wavelengths of the beams and provides each return beam to separate sets of optical detectors. For example, the local oscillator beam and the transmitted beam from optical source 802A may be directed to a 2x2 combiner 830A and corresponding optical detectors 832A-B while the beams from optical source 802B may be directed to 2x2 combiner 830B and corresponding optical detectors 834A-B. Accordingly, two independent and redundant measurements of a target can be generated via the two different optical beams with differing modulation. The redundant measurements can then be used to compute a final target measurement to reduce effects of noise due to speckle in return signals (e.g., by averaging or other computational methods).

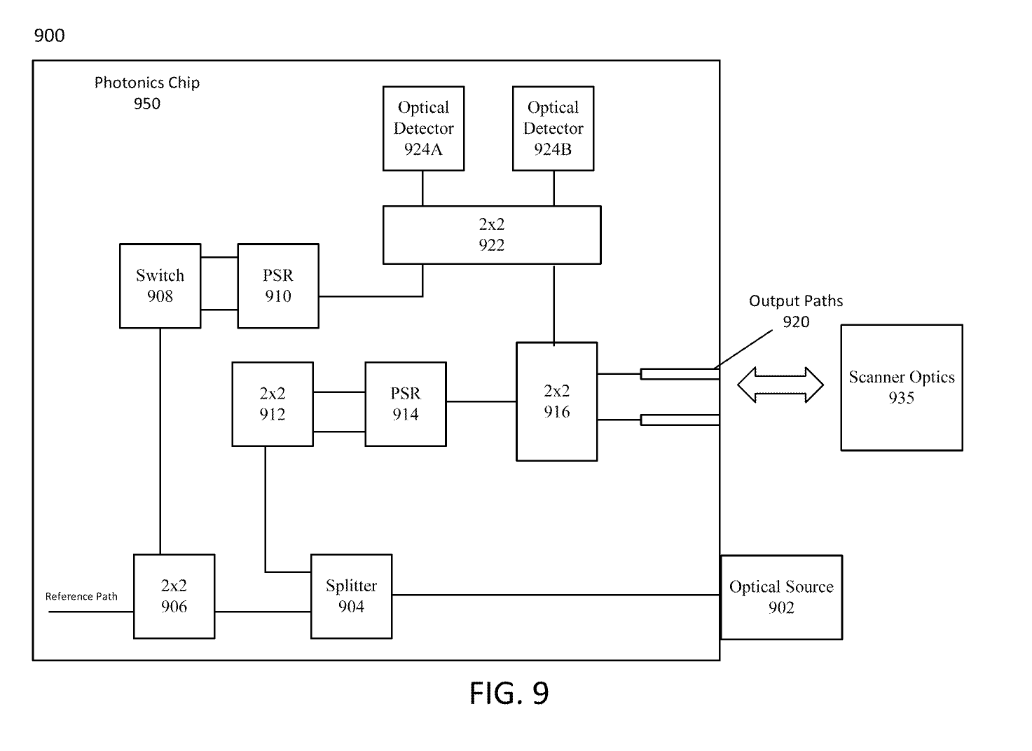

FIG. 9 illustrates an example LiDAR system 900 including optical circuity to perform target measurements using both TE and TM polarizations via separate optical beams, according to embodiments of the present disclosure. Another aspect of optical beam properties that can vary the speckle effect of a target is the polarization of the optical beam. Therefore, system 900 of FIG. 9 provides for the separation of polarizations (e.g., trans-magnetic and trans-electric polarizations) into two separate output paths of the LiDAR system, thus providing for varied polarization of redundant transmission beams as well as spatial variation between them.

As depicted, system 900 includes an optical source 902 to produce a frequency modulated optical beam. The optical source 902 may be coupled to a photonics chip 950 and may transmit the optical beam into the photonics chip 950. A beam splitter 904 may split the optical beam into a local path and a transmission path. The local path may include an additional 2x2 splitter 906 to split the local path into a reference beam and a local oscillator. The local oscillator may be provided to a 2x2 splitter or switch 908 to produce two separate paths to PSR 910. The PSR 910 may polarize a received beam from the paths differently. For example, the PSR 910 may polarize a beam in the first path into a TE polarization and polarize a beam in the second path into a TM polarization. Thus, the polarization of the beam output from the PSR 910 depends on the path selected by the switch 908.

The transmission path of the photonics chip 950 after splitter 904 may similarly include a 2x2 splitter 912 to split the transmission path into two paths input to PSR 914. As with PSR 910, PSR 914 may be configured to polarize a beam in the first path to a first polarization (e.g., TM polarization) and a beam in the second path to a second polarization (e.g., TE polarization). One or both beams may then be transmitted to another 2x2 combiner 916 which then provides two beams to two output paths 920. The scanner optics 935 may direct the beams toward a target, receive a reflected return signal and direct the return signal back to the output paths 920. The 2x2 combiner 916 then provides the return beam to a 2x2 combiner 922 to mix the local oscillator beam with the selected polarization with the return beams and provide the mixed signal to optical detectors 924A-B. Optical detectors 924A-B may generate an electrical signal including the beat frequency created from the combined beams.

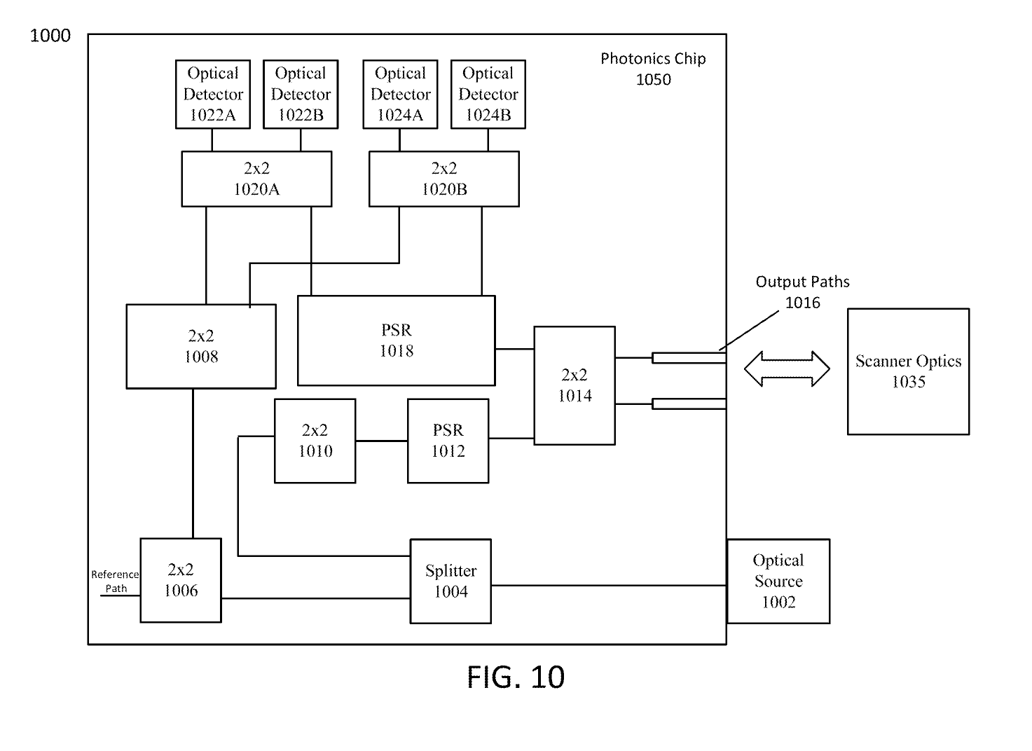

FIG. 10 illustrates another example LiDAR system 1000 including optical circuity to perform target measurements using both TE and TM polarizations via separate optical beams, according to embodiments of the present disclosure. System 1000 includes optical circuitry to measure signals for each polarization and each optical path by separating the polarizations in the return path rather than the output path. Similar to LiDAR system 900 discussed above, system 1000 includes an optical source 1002 to produce a frequency modulated optical beam. The optical source 1002 may be coupled to a photonics chip 1050 and may transmit the optical beam into the photonics chip 1050. A beam splitter 1004 may split the optical beam into a local path and a transmission path. The local path may include an additional 2x2 splitter 1006 to split the local path into a reference beam and a local oscillator. The local oscillator may be provided to a 2x2 splitter 1008 to produce two separate beams along two local oscillator signals to mix with return signals.

The transmission path of the photonics chip 1050 after splitter 1004 may similarly include a 2x2 splitter 1010 to split the transmission path into two paths input to PSR 1012. PSR 1012 may be configured to polarize a beam in the first path to a first polarization (e.g., TM polarization) and a beam in the second path to a second polarization (e.g., TE polarization). One or both beams may then be transmitted to another 2x2 combiner 1014 which then provides two beams to two output paths 1016. The scanner optics 1035 may direct the beams toward a target, receive a reflected return signal and direct the return signal back to the output paths 1016. The 2x2 1014 then provides the return beams to another PSR 1018 in the return path to direct the varying polarizations to different sets of optical detectors. For example, PSR 1018 may direct a beam with a first polarization (e.g., TM polarization) to a first 2x2 combiner 1020A and direct a beam with a second polarization (e.g., TE polarization) to a second 2x2 combiner 1020B. The first 2x2 combiner 1020A may then combine the first polarization with one of the local oscillator beams and provide the combined beam to optical detectors 1022A-B to generate a detection signal. The second 2x2 combiner 1020B may then combine the beam with the second polarization with a second local oscillator beam and provide the combined beam to optical detectors 1024A-B to generate another detection signal. Accordingly, using the two differing polarizations of the optical beam, embodiments may perform two redundant target detections or target measurements for the same target at the same time using a common original optical beam.

Alternatively, some embodiments may not include 2x2 1010 and PSR 1012 and rather may utilize the 2x2 1014 to separate the output beams in the output paths 1016 into separate polarizations or by transmitting the beam and separating the return beam via polarization by PSR 1014.

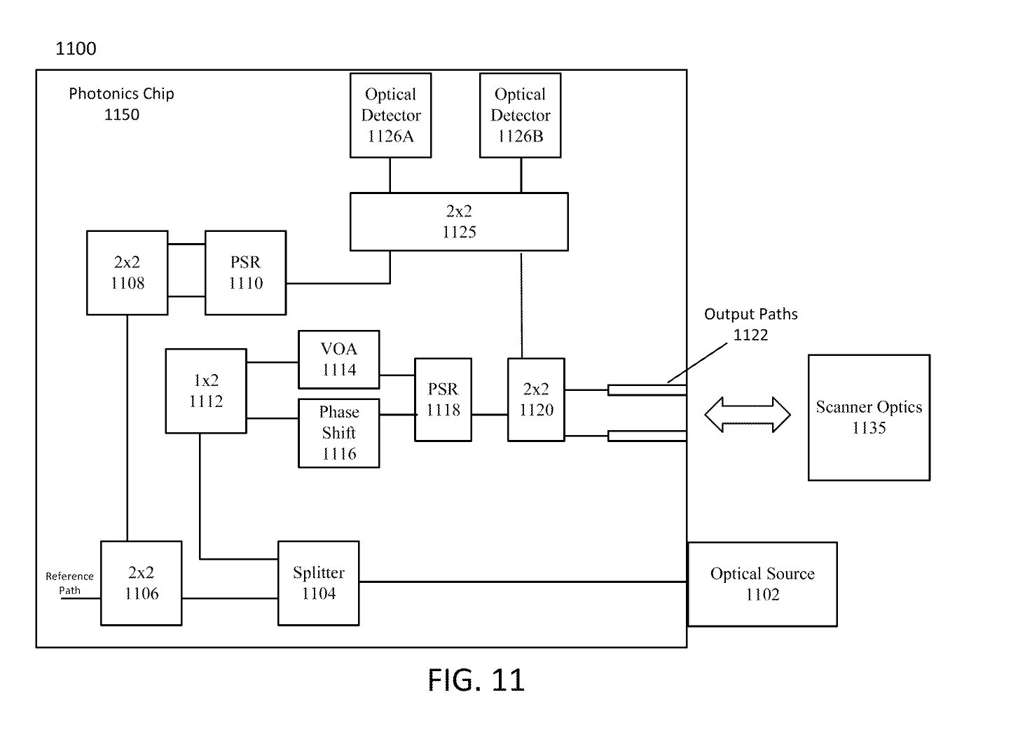

FIG. 11 illustrates an example LiDAR system 1100 including integrated photonics circuitry to generate varying and randomized polarizations for multiple output optical beams to generate redundant target measurements, according to some embodiments. As depicted, system 1100 includes an optical source 1102 to produce a frequency modulated optical beam. The optical source 1102 may be coupled to a photonics chip 1150 and may transmit the optical beam into the photonics chip 1150. A beam splitter 1104 may split the optical beam into a local path and a transmission path. The local path may include an additional 2x2 splitter 1106 to split the local path into a reference beam and a local oscillator. The local oscillator may be provided to a 2x2 splitter or switch 1108 to produce two separate paths to PSR 1110. The PSR 1110 may polarize a received beam from the paths differently. For example, the PSR 1110 may polarize a beam in the first path into a TE polarization and polarize a beam in the second path into a TM polarization. Thus, the polarization of the beam output from the PSR 1110 depends on the path selected by the switch 1108.

The transmission path of the photonics chip 1150 after splitter 1104 may include a 1x2 coupler 1112 that receives the transmission beam from the splitter 1104 and splits the beam into two paths. The first path includes a variable optical attenuator (VOA) 1114 and the second path includes a phase shift 1116. The VOA 1114 may attenuate the beam in the first path, which determines the resulting polarization of the optical beam as rotated by the PSR 1118. For example, a full attenuation of the beam by the VOA 1114 may result in no rotation of the beam by the PSR 1118 while no attenuation may result in a full 90 degree rotation (e.g., from TE polarization to TM polarization). Thus, varying of the attenuation may result in rotations somewhere between no rotation and a full 90 degree rotation. Additionally, to incorporate circular polarization into the resulting output beam, the phase shift 1116 in the second path may shift the phase of the optical beam in the second path. Thus, the resulting beam, when recombined after the PSR 1118, may include any variations of TE and TM polarizations as well as varying circular polarization. Thus, the combination of the VOA 1114, the phase shift 1116, and the PSR 1118 may provide for random variation of the polarization of the output optical beam to produce redundant and independent measurements of a target via varying polarizations.

The output optical beam with the varying polarizations may then be provided to scanner optics 1135 via one or more output paths 1122. The scanner optics 1135 may direct the optical beam toward a target and receive a return signal reflected from the target. The scanner optics may direct the return beam to the paths 1122. The return signal may then be directed to a 2x2 combiner 1125 for mixing the return signal with the polarized local oscillators from PSR 1110. The 2x2 combiner 1125 may then combine the beam with the local oscillator signal and provide the combined beam to optical detectors 1126A-B to generate a detection signal.

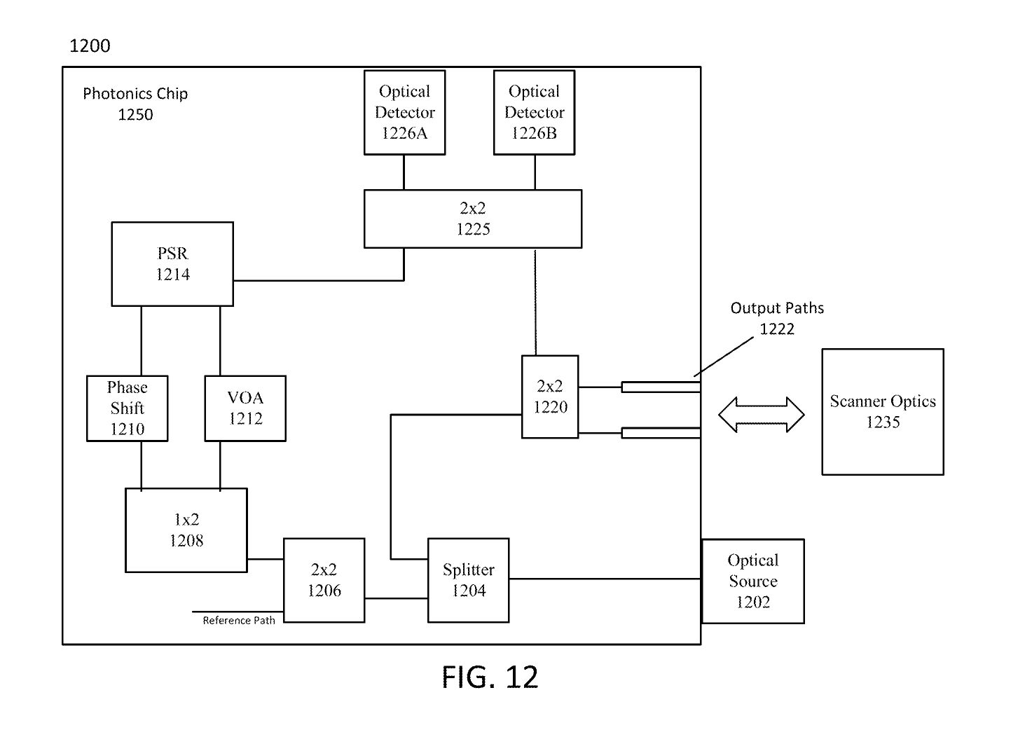

FIG. 12 illustrates an example LiDAR system 1200 including integrated photonics circuity to vary and randomize local oscillator polarizations for combination with multiple optical beams to generate redundant target measurements, according to embodiments of the present disclosure. As depicted, system 1200 includes an optical source 1202 to produce a frequency modulated optical beam. The optical source 1202 may be coupled to a photonics chip 1250 and may transmit the optical beam into the photonics chip 1250. A beam splitter 1204 may split the optical beam into a local path and a transmission path. The local path may include an additional 2x2 splitter 1206 to split the local path into a reference beam and a local oscillator. The local oscillator may be provided. The local oscillator path of the photonics chip 1250 after splitter 1206 may include a 1x2 coupler 1208 that receives the local oscillator beam from the splitter 1206 and splits the beam into two paths. The first path includes a variable optical attenuator (VOA) 1212 and the second path includes a phase shift 1210. The VOA 1212 may attenuate the beam in the first path, which determines the resulting polarization of the optical beam as rotated by the PSR 1214. For example, a full attenuation of the beam by the VOA 1212 may result in no rotation of the beam by the PSR 1214 while no attenuation may result in a full 90-degree rotation (e.g., from TE polarization to TM polarization). Thus, varying of the attenuation may result in rotations somewhere between no rotation and a full 90-degree rotation. Additionally, to incorporate circular polarization into the resulting local oscillator beam, the phase shift 1210 in the second path may shift the phase of the optical beam in the second path. Thus, the resulting beam, when recombined after the PSR 1214, may include any variations of TE and TM polarizations as well as varying circular polarization. Thus, the combination of the VOA 1212, the phase shift 1210, and the PSR 1214 may provide for random variation of the polarization of the local oscillator beam.

The transmission path of photonics chip 1250 may include a 2x2 splitter 1220 to provide the output optical beam to output paths 1222. The output optical beam may then be provided to scanner optics 1235 via the one or more output paths 1222. The scanner optics 1235 may direct the optical beam toward a target and receive a return signal reflected from the target. The scanner optics may direct the return beam to the paths 1222. The return signal may then be directed to a 2x2 combiner 1225 for mixing the return signal with the local oscillator having the randomly varying polarization from PSR 1214. The 2x2 combiner 1225 may then combine the beam with the local oscillator signal and provide the combined beam to optical detectors 1226A-B to generate a detection signal.

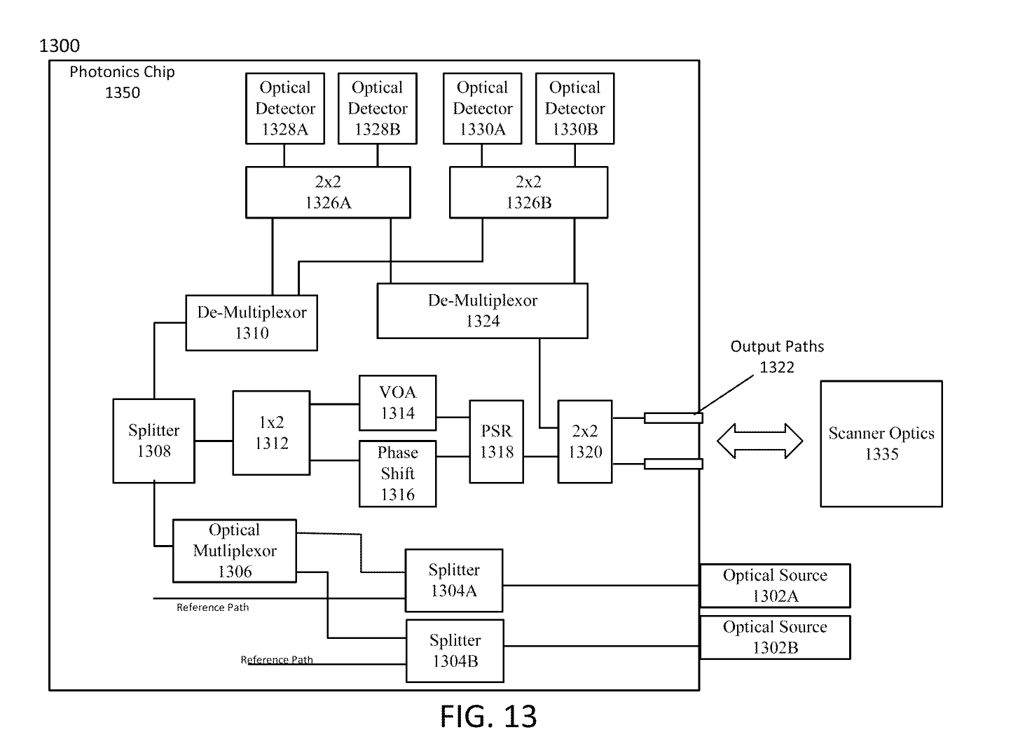

FIG. 13 illustrates an example LiDAR system 1300 including multiple optical beams and integrated photonics circuitry to randomly vary a polarization of the optical beams to produce redundant target measurements, according to embodiments of the disclosure. In some embodiments, LiDAR system 1300 includes two optical sources 1302A-B, each with a different frequency or frequency modulation. For example, the optical sources 1302A-B may be counter-chirped where each are modulated about a common or similar frequency but the up chirp of one optical source corresponds to the down chirp of the other source. Thus, each are operating with a differing modulation to produce two differing signals to measure the same target. The optical beam of optical source 1302A may be split by splitter 1304A into a reference path and a transmission path and the optical beam of optical source 1302B may be split by splitter 1304B into a reference path and transmission path. The two optical beams may then be combined into a single path via optical multiplexor 1306, resulting in a combined beam. A beam splitter 1308 may split the combined beam into a local oscillator and a combined transmission beam. The splitter 1308 may direct the local oscillator to a wavelength de-multiplexor 1310 that separates the two beams included in the local oscillator based on the wavelengths of the beams and provides each beam to separate sets of optical detectors.

The transmission path of the photonics chip 1350 after splitter 1308 may include a 1x2 coupler 1312 that receives the transmission beam from the splitter 1308 and splits the beam into two paths. The first path includes a variable optical attenuator (VOA) 1314 and the second path includes a phase shift 1316. The VOA 1314 may attenuate the beam in the first path, which determines the resulting polarization of the optical beam as rotated by the PSR 1318. For example, a full attenuation of the beam by the VOA 1314 may result in no rotation of the beam by the PSR 1318 while no attenuation may result in a full 90-degree rotation (e.g., from TE polarization to TM polarization). Thus, varying of the attenuation may result in rotations somewhere between no rotation and a full 90-degree rotation. Additionally, to incorporate circular polarization into the resulting output beam, the phase shift 1316 in the second path may shift the phase of the optical beam in the second path. Thus, the resulting beam, when recombined after the PSR 1318, may include any variations of TE and TM polarizations as well as varying circular polarization. Thus, the combination of the VOA 1314, the phase shift 1316, and the PSR 1318 may provide for random variation of the polarization of the output optical beam to produce redundant and independent measurements of a target via varying polarizations.

The output optical beam with the varying polarizations may then be provided to scanner optics 1335 via one or more output paths 1322. The scanner optics 1335 may direct the optical beam toward a target and receive a return signal reflected from the target. The scanner optics may direct the return beam to the paths 1322. The return signal may then be directed to a de-multiplexor 1324 to split the returned signal into the respective wavelength/frequency components. Each return signal may be provided to a respective 2x2 combiner 1326A and 1326B to combine the respective beam with the corresponding local oscillator signal from de-multiplexor 1310. The combined signals may then be provided to optical detectors 1328A-B for the first signal and optical detectors 1330A-B for the second signal to generate to separate measurements for the two optical sources 1302A-B as well as generating redundant measurements using varying polarizations of the output optical beams.

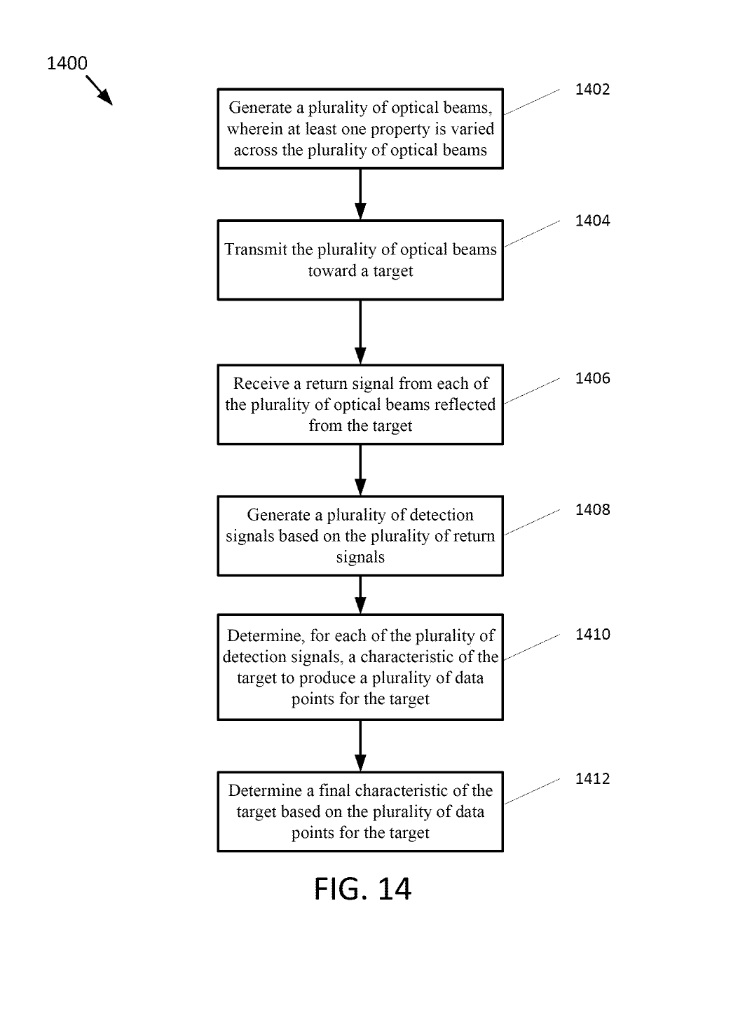

FIG. 14 is a flow diagram illustrating a method 1400 of speckle reduction using multiple redundant target measurements, according to embodiments of the disclosure. In embodiments, various portions of method 1400 may be performed by LIDAR systems of FIG. 1 and FIGS. 3-13. With reference to FIG. 14, method 1400 illustrates example functions used by various embodiments. Although specific function blocks ("blocks") are disclosed in method 1400, such blocks are examples. That is, embodiments are well suited to performing various other blocks or variations of the blocks recited in method 1400. It is appreciated that the blocks in method 1400 may be performed in an order different than presented, and that not all of the blocks in method 1400 may be performed.

At block 1402, a plurality of optical beams are generated, wherein at least one optical beam property is varied across the plurality of optical beams. In some embodiments, the at least one property that is varied across the plurality of optical beams comprises a spatial adjustment between the plurality of output beams. The spatial adjustment may include selecting between multiple output optical paths. In some embodiments the at least one property that is varied across the plurality of optical beams comprises a varied wavelength of the plurality of output beams. Varying the wavelength of the plurality of optical beams may include selecting an output beam from one of a plurality of optical sources. In some embodiments, the at least one property that is varied across the plurality of optical beams includes a varied polarization of the output beam. In some embodiments, varying the polarization state may include randomly varying the polarization state via a polarization randomizer. In some embodiments, varying the polarization state may include selecting, via a switch in the output path, a polarization of the output optical beam. In some embodiments, rather than vary the polarization of the output beam, a polarization of the local oscillator signal may be varied, either by selection or via randomly varying the polarization state of the local oscillator.

At block 1404, the plurality of optical beams are transmitted toward a target in the field of view of the LiDAR system. At block 1406, a return signal is received from each of the plurality of optical beams reflected from the target. At block 1408, a plurality of detection signals are generated based on the plurality of return signals.

At block 1410, a characteristic of the target is determined for each of the plurality of detection signals to produce a plurality of data points for the target. The characteristic may be a range (e.g., distance to the target), velocity, reflectivity or other characteristic of the target that can be determined from the return signal.

At block 1412, a final characteristics of the target is determined based on the plurality of data points for the target. In some embodiments, determining the final characteristic of the target includes calculating one of an average or a weighted average of the plurality of data points for the target. In some embodiments, determining the final characteristic includes determining whether each of the plurality of data points of the target are valid based on one or more of a threshold velocity, a threshold range, or a threshold intensity and removing invalid data points from the determination of the final characteristic value.

FIG. 15 is a flow diagram illustrating another method 1500 of speckle reduction using multiple redundant target measurements, according to embodiments of the disclosure. In embodiments, various portions of method 1500 may be performed by LIDAR systems of FIG. 1, and FIGS. 3-14. With reference to FIG. 15, method 1500 illustrates example functions used by various embodiments. Although specific function blocks ("blocks") are disclosed in method 1500, such blocks are examples. That is, embodiments are well suited to performing various other blocks or variations of the blocks recited in method 1500. It is appreciated that the blocks in method 1500 may be performed in an order different than presented, and that not all of the blocks in method 1500 may be performed.

Method 1500 begins at block 1502, where a plurality of independent measurements for a target are collected, using varied optical beam properties, as described above with respect to any one of FIGS. 3-13. Processing logic may then select valid data points via one or more metrics as described below and replace invalid data points.

At block 1504, processing logic determines, for each independent measurement collected within a particular integration time, whether one or more selected metrics are satisfied by the measurement. For example, the one or more metrics may include intensity, SNR, velocity, quality of the return signal, phase variation across the return signal area, etc. If the threshold are satisfied for each data point, then the process can proceed to block 1514 for calculating an average, or other arithmetic operation, for the data points because all data points collected are determined valid.

If, however, a data point does not satisfy the first thresholds for each metric, the process proceeds to block 1506, where processing logic determines, for each measurement not satisfying the first threshold, whether it satisfies a second threshold for the metrics (e.g., a minimum threshold for validity). If the measurement does not satisfy the second threshold for each metric then the measurement is invalid and the invalid data point is removed at block 1508. If the metrics do satisfy the second threshold, then processing logic proceeds to block 1510.

At block 1510, processing logic determines, for the remaining data points, if the metrics satisfy a third threshold (e.g., a replacement threshold). If no data points satisfy the third threshold, then processing logic continues to block 1514, where a final value for the measurement is determined (e.g., by calculating an average of the remaining set of valid data points). The third threshold may be a threshold indicating a high likelihood of data point validity. Thus, if the metrics for the remaining data points, or one or more of the remaining data points, then processing logic replaces, at block 1512, invalid data points with data points that are indicated as valid by the third threshold. Once invalid data points are replaced, the process proceeds to block 1514 to calculate the final value for the measurement.

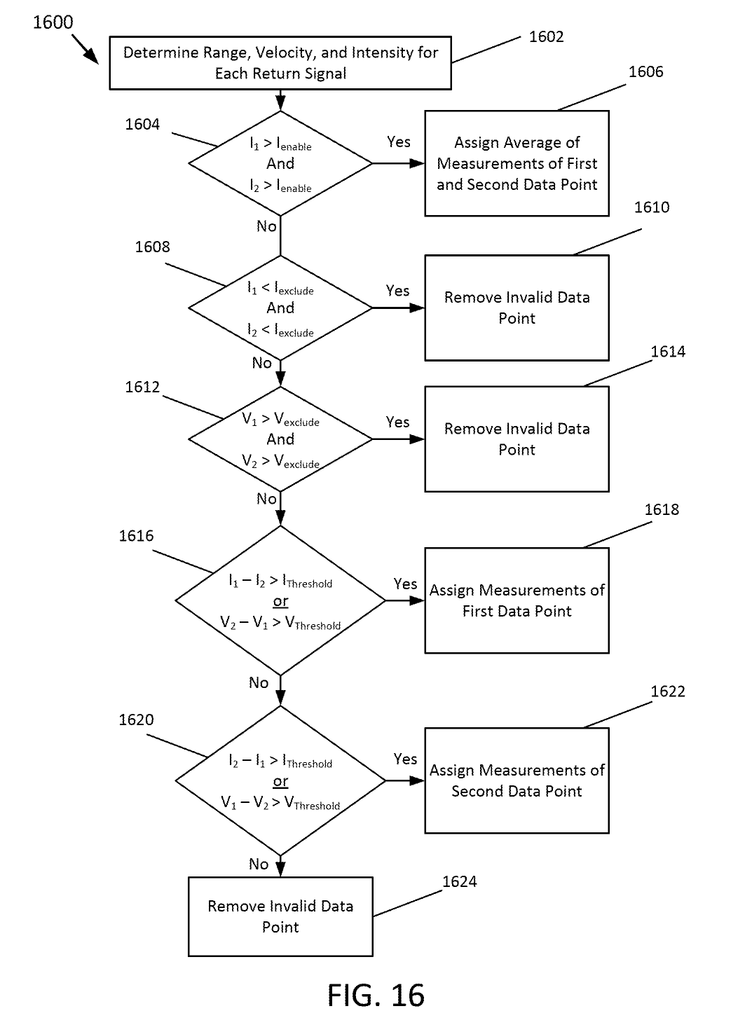

FIG. 16 is a flow diagram illustrating a method 1600 of speckle reduction using two redundant target measurements, according to embodiments of the present disclosure. In embodiments, various portions of method 1600 may be performed by LIDAR systems of FIGS. 3-13. With reference to FIG. 16, method 1600 illustrates example functions used by various embodiments. Although specific function blocks ("blocks") are disclosed in method 1600, such blocks are examples. That is, embodiments are well suited to performing various other blocks or variations of the blocks recited in method 1600. It is appreciated that the blocks in method 1600 may be performed in an order different than presented, and that not all of the blocks in method 1600 may be performed.

At block 1602, an independent range, velocity, and signal intensity measurement is made for two independent and redundant return signals received at a LiDAR system are determined.

At block 1604, processing logic determines whether the intensity of each of the measurements is above an intensity based enabling threshold indicating that both points are valid. If both measurements are above the intensity based enabling threshold, then processing logic uses an average of the two measurements to determine range, velocity and intensity at block 1606. Otherwise, if processing logic determines that one or both of the intensities of the measurements are below the intensity based enabling threshold, the process proceeds to block 1608.

At block 1608, processing logic determines if the intensities of both measurements are below an intensity based exclusion threshold, indicating that both measurements are invalid. If the intensities of both measurements are below the intensity based exclusion threshold, then processing logic removes the entire data point (e.g., both measurements) from performing target detection, at block 1610. Similarly, at block 1612, processing logic determines whether the velocity measurement for both return signals is above a velocity based exclusion threshold, indicating that the measurements are invalid. Accordingly, if both velocity measurements are above the velocity based exclusion threshold, processing logic removes the entire data point (e.g., both measurements) from target detection at block 1614.

If, however, at least one of the measurements include an intensity above the intensity based exclusion threshold at block 1608 and at least one of the measurements include a velocity below the velocity based exclusion threshold at block 1612, the process proceeds to block 1616. At block 1616, processing logic determines if a first measurement is better than a second measurement by determining if a different in intensity of the first measurement and the second measurement is above a threshold intensity difference (e.g., if the first intensity is sufficiently higher than the second intensity) of if a difference between the second velocity and the first velocity is greater than a threshold velocity difference. If either of the differences exceed the corresponding thresholds, processing logic assigns the first measurement to the datapoint at block 1618. In other words, the processing logic determines that the first measurement is the better measurement with respect to intensity or velocity and utilizes the first measurement and disregards the second measurement.

If neither threshold differences are satisfied at block 1616, the process proceeds to block 1620. At block 1620, processing logic determines whether the second measurement is the better, more accurate measurement. In particular, the processing logic determines if the second measurement is better than a first measurement by determining if a difference in intensity of the second measurement and the first measurement is above a threshold intensity difference (e.g., if the second intensity is sufficiently higher than the first intensity) of if a difference between the first velocity and the second velocity is greater than a threshold velocity difference. If either of the differences exceed the corresponding thresholds, processing logic assigns the second measurement to the datapoint at block 1622. If, however, neither of the threshold differences are satisfied at block 1620, the entire data point is removed at block 1624. This process may be repeated for each set of redundant target measurements detected by the LiDAR system.

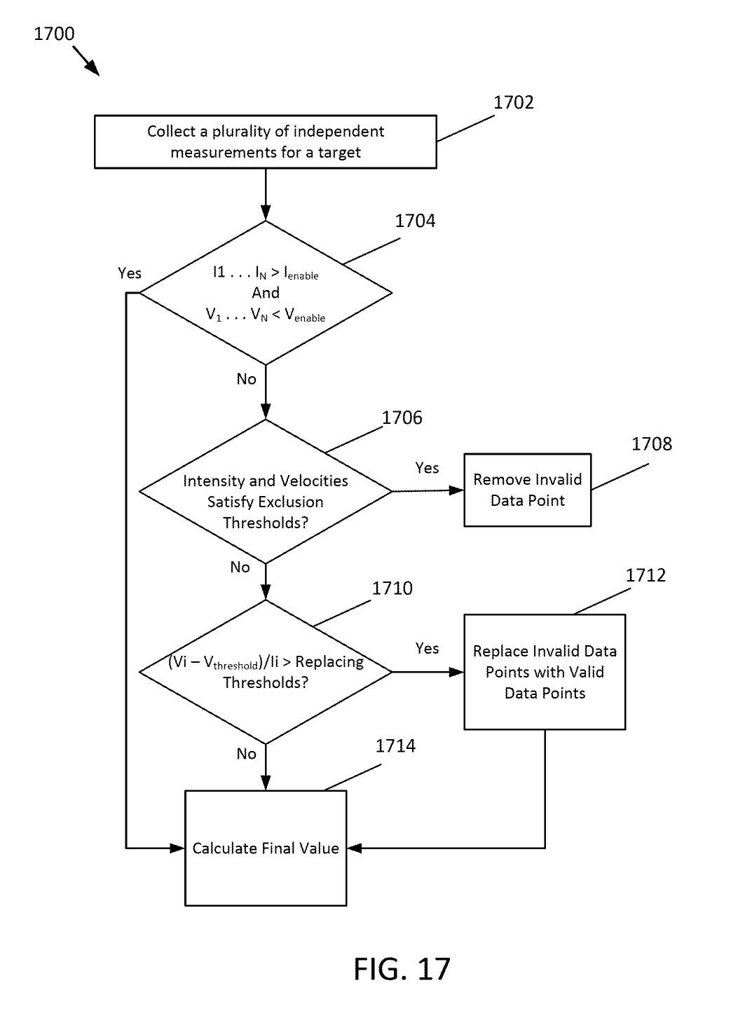

FIG. 17 is a flow diagram illustrating an example method 1700 of speckle reduction in a LiDAR system using any arbitrary number of redundant target measurements, according to embodiments of the present disclosure. In embodiments, various portions of method 1700 may be performed by LIDAR systems of FIGS. 3-13. With reference to FIG. 17, method 1700 illustrates example functions used by various embodiments. Although specific function blocks ("blocks") are disclosed in method 1700, such blocks are examples. That is, embodiments are well suited to performing various other blocks or variations of the blocks recited in method 1700. It is appreciated that the blocks in method 1700 may be performed in an order different than presented, and that not all of the blocks in method 1700 may be performed.

At block 1702, where a plurality of independent measurements for a target are collected, using varied optical beam properties, as described above with respect to any one of FIGS. 3-13. Processing logic may then select valid data points via one or more metrics as described below and replace invalid data points.

At block 1704, processing logic determines whether each of the independent measurements collected for the target are valid based on an intensity threshold and a velocity threshold. If all of the measurements include an intensity that is above the intensity threshold and a velocity that is below the velocity threshold, then all points are valid measurements and the process proceeds to calculate a final value for the data point based on all of the collected measurements. If one or more measurements do not satisfy the threshold, then the process proceeds to filter and replace invalid measurements.

At block 1706, processing logic determines, for each measurement, whether an intensity based exclusion threshold is satisfied and if a velocity based exclusion threshold is satisfied. If a measurement includes a velocity that exceeds the velocity based exclusion threshold or if the intensity is less than the intensity based exclusion threshold, the measurement is invalid and processing logic removes the measurement at block 1708 from the set of measurements (e.g., the measurement is not used in a final calculation for the data point). After removing the invalid measurements from the set of measurements for the data point, at block 1710, processing logic determines which of the remaining measurements, if any, should be used to replace the invalid data points that were removed. To determine whether a data point is sufficiently valid to replace invalid data points, processing logic may calculate an invalidity score for each data point and replace any data points with an invalidity score above a threshold with data points that are indicated as valid (e.g., that have invalidity scored below the threshold). For example, the invalidity score may include calculating the difference between a measured velocity and a threshold velocity and dividing that difference by the measured intensity of the data point. Thus, a higher velocity and lower intensity level may result in a higher likelihood of an invalid data point.

Following the elimination of invalid data points, a sorting mechanism is employed to rank the measured data based on the quality of the metrics. Empirically, data points influenced by speckle interference often exhibit higher velocity and lower intensity levels in the return signal.

At block 1714, processing logic calculates a final value for the data point based on the remaining and current measurements in the data set after filtering and replacing invalid data points. In some embodiments, a weighted arithmetic value of the remaining measurements is computed to determine the final value for the data point.

The preceding description sets forth numerous specific details such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular embodiments may vary from these exemplary details and still be contemplated to be within the scope of the present disclosure.

Additionally, some embodiments may be practiced in distributed computing environments where the machine-readable medium is stored on and or executed by more than one computer system. In addition, the information transferred between computer systems may either be pulled or pushed across the communication medium connecting the computer systems. Embodiments of the claimed subject matter include, but are not limited to, various operations described herein. These operations may be performed by hardware components, software, firmware, or a combination thereof.

The preceding description sets forth numerous specific details such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular embodiments may vary from these exemplary details and still be contemplated to be within the scope of the present disclosure.

Reference throughout this specification to “one embodiment” or “an embodiment” means that a particular feature, structure, or characteristic described in connection with the embodiments included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or.”

Although the operations of the methods herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent or alternating manner.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Furthermore, the terms “first,” “second,” “third,” “fourth,” etc. as used herein are meant as labels to distinguish among different elements and may not necessarily have an ordinal meaning according to their numerical designation.

What is claimed is:

1. A method of operating a light detection and ranging (LIDAR) system comprising:
generating a plurality of optical beams, wherein a property is varied across the plurality of optical beams;
transmitting the plurality of optical beams toward a target;
receiving a return signal from each of the plurality of optical beams reflected from the target;
generating a plurality of detection signals based on the plurality of return signals;
determining, for each of the plurality of detection signals, a characteristic of the target to produce a plurality of data points for the target; and
determining an updated characteristic of the target based on the plurality of data points for the target.

2. The method of claim 1, wherein determining the updated characteristic of the target comprises calculating one of an average or a weighted average of the plurality of data points for the target.

3. The method of claim 1, wherein determining the updated characteristic comprises:
determining whether each of the plurality of data points of the target are valid based on one or more of a threshold velocity, a threshold range, or a threshold intensity; and
removing invalid data points from the determination of the updated characteristic.

4. The method of claim 1, wherein the at least one property that is varied across the plurality of optical beams comprises a spatial adjustment between the plurality of optical beams.

5. The method of claim 4, wherein the spatial adjustment comprises selecting between a plurality of output optical paths.

6. The method of claim 1, wherein the at least one property that is varied across the plurality of optical beams comprises a varied wavelength of the plurality of optical beams.

7. The method of claim 6, wherein varying the wavelength of the plurality of optical beams comprises selecting an output beam from one of a plurality of optical sources.

8. The method of claim 1, wherein the at least one property that is varied across the plurality of optical beams comprises a varied polarization state of an output optical beam.

9. The method of claim 8, wherein varying the polarization state comprises randomly varying the polarization state via a polarization randomizer.

10. The method of claim 9, wherein varying the polarization state comprises selecting, via a switch in an output path, a polarization of an output optical beam.

11. The method of claim 1, wherein the at least one property that is varied across the plurality of optical beams comprises a varied polarization of a local oscillator.

12. A light detection and ranging (LIDAR) system, comprising:
one or more optical sources to generate a plurality of optical beams, wherein a property is varied across the plurality of optical beams;
integrated photonics and scanning optics to transmit the plurality of optical beams toward a target and receive a return signal from each of the plurality of optical beams reflected from the target;
a plurality of optical detectors to generate a plurality of detection signals based on the plurality of return signals; and
a processing device, operatively coupled to the plurality of optical detectors, to:
determine, for each of the plurality of detection signals, a characteristic of the target to produce a plurality of data points for the target; and
determine an updated characteristic of the target based on the plurality of data points for the target.

13. The system of claim 12, wherein to determine the updated characteristic of the target, the processing device is to:
calculate one of an average or a weighted average of the plurality of data points for the target.

14. The system of claim 12, wherein to determine the updated characteristic, the processing device is to:
determine whether each of the plurality of data points of the target are valid based on one or more of a threshold velocity, a threshold range, or a threshold intensity; and
remove invalid data points from the determination of the updated characteristic.

15. The system of claim 12, wherein the at least one property that is varied across the plurality of optical beams comprises a spatial adjustment between the plurality of optical beams.

16. The system of claim 15, wherein the spatial adjustment comprises selecting between a plurality of output optical paths.

17. The system of claim 12, wherein the at least one property that is varied across the plurality of optical beams comprises a varied wavelength of the plurality of optical beams.

18. The system of claim 17, wherein varying the wavelength of the plurality of optical beams comprises selecting an output beam from one of a plurality of optical sources.

19. The system of claim 12, wherein the at least one property that is varied across the plurality of optical beams comprises a varied polarization state of an output optical beam.

20. The system of claim 19, wherein varying the polarization state comprises randomly varying the polarization state via a polarization randomizer.
